(19) United States
(12) Patent Application Publication
(10) Pub. No.: US 2026/0354352 A1
(43) Pub. Date: Nov. 12, 2026

(54) Machine Learning Based Auditory Activity Monitoring for Livestock Health and Welfare

(71) Applicant: MACSO Technologies Limited, Auckland (NZ)

(72) Inventors: Saba Samiei, Auckland (NZ); Hwan Goh, Auckland (NZ); Hanxiao Zhang, Auckland (NZ); Philippe Rivard, Carlsbad, CA (US)

(73) Assignee: MACSO Technologies Limited, Auckland (NZ)

(21) Appl. No.: 19/134,600

(22) PCT Filed: Nov. 29, 2023
(86) PCT No.: PCT/US2023/081575

§ 371 Date: May 30, 2025

Related U.S. Application Data
(60) Provisional application No. 63/428,948, filed on Nov. 30, 2022.

(51) Int. Cl. A01K 29/00; G10K 11/178

(52) U.S. Cl. CPC A01K 29/005; G10K 11/17823; G10K 2210/3025; G10K 2210/3038

(57) ABSTRACT

Health and welfare of animals may be performed by network edge devices using neural networks trained on a server. The network edge devices may include a sensor for sensing conditions of an enclosure or range for animals, and a processor for performing neural network processing to indicate activity of interest detected by the sensor. Reports of activity of interest may be communicated to a server or other compute device for display on a dashboard.

### BACKGROUND OF THE INVENTION

The present invention relates generally to auditory monitoring for livestock health and welfare, and more particularly to auditory monitoring for livestock health and welfare using network edge devices performing neural network processing.

Livestock have been raised and kept for a variety of uses for eons. Raising of livestock faces numerous vicissitudes, including adverse weather, predation, and a host of others. In modern animal husbandry, which may include large numbers of animals on a single range or in a single or adjoining enclosures, disease may be of particular concern to ranchers and farmers. In such circumstances, care or removal of diseased animals may be particularly important.

Unfortunately, modern animal husbandry methods may also include the use of relatively limited numbers of people to monitor the health and welfare of relatively large numbers of animals. The presence of relatively few people may increase the difficulty of detection and identification of sick animals.

### BRIEF SUMMARY OF THE INVENTION

Some aspects of the invention provide for monitoring of health and/or welfare of animals by network edge devices. The network edge devices include a sensor and a processor implementing a neural network for detecting a sensed activity or activities of interest. Some embodiments include a filter for filtering output of the sensor, and a further neural network for determining filter parameters. In some embodiments the sensor is an audio sensor. In some embodiments the sensor is a temperature sensor. In some embodiments the sensor is an image sensor. In some embodiments the sensor is an aerosol sensor. In some embodiments the sensor is an infra-red image sensor.

In some embodiments the neural networks are trained using large scale computational devices, for example a computer or server, with implementation of the neural networks downloaded to the network edge devices. In some embodiments the neural network for detecting sensed activities is trained using data indicative of sounds indicative of disease of livestock and/or sounds related to ill effects on the welfare of animals. In some embodiments the neural network for determining filter parameters is trained using data indicative of ambient sounds of a livestock enclosure or range.

In some embodiments indications of reports of sensed activities of interest are provided by the network edge device to a remote compute device. In some embodiments the indications of reports are provided to the remote compute device by way of the Internet. In some embodiments the indications of reports are stored in a database maintained by one or more servers coupled to the Internet, and information of the database is provided to the remote compute device. In some embodiments the remote compute device presents information indicating reports of ill health or welfare of the animals.

In some embodiments the sensor is an audio sensor providing a digital output. In some embodiments the filter includes an analog-to-digital converter of the audio sensor, or circuitry associated with the analog-to-digital converter. In some embodiments the filter is external to the sensor. In some embodiments the filter is an infinite impulse response (IIR) filter. In some embodiments the filter is a finite impulse response (FIR) filter.

In some embodiments the processor includes frequency transform processing circuitry, circuitry for binning outputs of the frequency transform processing circuitry, and neural network circuitry for detecting auditory activities of interest using the binned outputs. In some embodiments the circuitry is circuitry of a general purpose processor configured by program instructions. In some embodiments the processor is programmed by program instructions to provide frequency transform processing, binning of outputs of the frequency transform processing, and neural network processing for detecting auditory activities of interest using the binned outputs. In some embodiments the frequency transform processing circuitry implements short-time Fourier transform (STFT) processing. In some embodiments the processor additionally includes neural network circuitry for determining filter parameters for the filter. In some embodiments the filter parameters are filter coefficients or filter weights.

Some aspects of the invention detect multiple different forms of vocal activity for multiple types of livestock by way of the classification capability of neural networks. Some embodiments utilize a machine learning noise filtration algorithm that is tuned using training information from a particular site or similar site. That is, a neural network is exposed to specific ambient noise signals at the target deployment site during the training process so that it will filter out these noise signals during the live inference process.

In some aspects of the invention initial neural network training is performed on the cloud, examples of such services include but are not limited to AWS SageMaker, Azure training services, etc. In some aspects the neural network and all accompanying firmware is remotely flashed onto an edge device via an over-the-air (OTA) update system that takes a .bin file on AWS S3 and flashes it onto the devices in the field, for example via WiFi or LoRaWAN. In some embodiments the firmware includes a neural network for classification of activity of interest, a neural network for noise filtration parameter determinations, over-the-air (OTA) software specifics (e.g., frequency of update, .bin file location, WiFi credentials, device specific identifiers, etc.), STFT specific codes, and/or noise filtration specific codes. In some embodiments both the classification and noise filtration networks are trained using Tensorflow. In some embodiments compression of the neural networks and flashing onto an ESP32 device is performed using the Tensorflow Lite library.

In some embodiments the live inference on the edge and the communication to a dashboard displaying results by a user for use in determining corrective action include some or all of the following activities: The audio signal is converted into a digital signal; An STFT is performed on a frame of processed signal to produce a spectrogram; The spectrogram frequencies are pooled into frequency bins; The frequency bins are stacked and fed into the noise filtration neural network to output filter parameters (for example equalizer gains, filter weights or coefficients); The equalizer gains are used to scale the coefficients of an IIR or FIR filter (or other filter) that is used to reconstruct the denoised signal; An STFT is performed on the denoised signal to produce another spectrogram; the spectrogram frequencies are again pooled into frequency bins; The frequency bins are fed into the classification neural network to determine whether an auditory activity of interest occurred; If the output of the neural network indicates an auditory activity of interest, this is communicated to AWS IoT Core via MQTT; The messages on AWS IoT Core are then routed to an AWS Timestream database; and The browser based customer facing dashboard periodically checks the AWS Timestream database to display contents of the database.

Some embodiments provide a method for determining activity of interest relating to livestock health and/or welfare, comprising: for each of a plurality of sensor and processor pairs: receiving, from the sensor, a signal indicative of input sensed by the sensor relating to livestock; performing, by the processor, a transform on the received signal; performing, by the processor, activity of interest neural network processing on the transformed signal to determine if an activity of interest has occurred, the activity of interest occurring if the sensed input is indicative of ill health and/or poor welfare of livestock; and transmitting an indication of the activity of interest to a server.

Some embodiments further provide filtering the signal indicative of input sensed by the sensor relating to livestock, and wherein the processor performs the transform on the filtered received signal.

Some embodiments further provide binning the transformed signal, and wherein the processor performs activity of interest neural network processing on the binned, transformed signal.

In some embodiments the sensors are audio sensors. In some embodiments the sensors are image sensors. In some embodiments the sensors are temperature sensors. In some embodiments the sensors are aerosol sensors. In some embodiments the sensors are infra-red sensors.

In some embodiments the transform is a short-time Fourier transform (STFT) and the binning of the transformed signal pools results of the STFT into frequency bins.

In some embodiments the machine learning training is performed using information indicative of ill health and/or poor welfare of livestock. In some embodiments the sensors are sound sensors, and the machine learning training is performed using information of sounds indicative of ill health and/or poor welfare of livestock.

Some embodiments further provide filtering the received signal, wherein the processor performs the transform on the filtered received signal.

In some embodiments a noise filter neural network performs the filtering of the received signal by operating on the received signal.

In some embodiments a noise filter neural network determines filter parameters of a filter to filter the received signal. Some embodiments further provide performing machine learning training, on a server, to train a noise filter neural network to determine filter parameters to filter ambient sounds in a livestock range or enclosure; and downloading the trained noise filter neural network to the processors of the sensor and processor pairs.

In some embodiments the machine learning training of the noise filter neural network is performed using ambient sounds in the livestock range or enclosure.

In some embodiments the livestock is pigs, and the sensor and processor pairs are spread about a pig farm. In some embodiments at least one sensor and processor pair is provided per pig enclosure.

In some embodiments the livestock is cattle, and the sensor and processor pairs are spread about a range utilized by cattle. In some embodiments the livestock is cattle, and a sensor and processor pair is provided to each cow or bull.

Some embodiments provide a system for determining activity of interest relating to livestock health and/or welfare, comprising: a plurality of network edge devices, the network edge devices each including a sensor and a processor, the processor configured to perform a transform on sensor outputs, to perform activity of interest neural network processing on the transformed sensor outputs to determine occurrence of an activity of interest relating to livestock health and/or welfare, and to command transmission of indications of occurrence of activities of interest to a remote compute device.

In some embodiments the network edge devices additionally include a filter for filtering output of the sensor. In some embodiments the network edge devices additionally include network communication circuitry. In some embodiments the transform is a short-time Fourier transform (STFT). In some embodiments the processor is further configured to bin results of the STFT, with the processor configured to perform activity of interest neural network processing on the binned results of the STFT. In some embodiments the processor is configured to perform activity of interest neural network processing using a neural network trained to identify signals indicative of ill health and/or poor welfare of livestock. In some embodiments the sensor is an audio sensor. In some embodiments the sensor is an image sensor. In some embodiments the sensor is a temperature sensor. In some embodiments the sensor is an aerosol sensor. In some embodiments the sensor is an infra-red sensor. In some embodiments the signals indicative of diseased livestock comprise sounds indicative of ill health and/or poor welfare of livestock. In some embodiments the network edge devices additionally include a filter for filtering output of the sensor. In some embodiments the processor includes a first processing chain including a first short-time Fourier transform (STFT) module, a first binning module, and an activity of interest neural network, arranged to operate sequentially on a signal provided by the filter, and a second processing chain including a second STFT module, a second binning module, and a network filter neural network, also arranged to operate sequentially on the signal provided by the filter.

These and other aspects of the invention are more fully comprehended upon review of this disclosure.

### BRIEF DESCRIPTION OF THE FIGURES

FIG. 1 is semi-block diagram of a system for determining activity of interest related to livestock health and/or welfare using neural network equipped edge devices, in accordance with aspects of the invention.

FIG. 2 is a flow diagram of a process including determining activities of interest relating to livestock health and/or welfare, in accordance with aspects of the invention.

FIG. 3 is a flow diagram of a process for determining auditory activities of interest, in accordance with aspects of the invention.

FIG. 4a is a flow diagram of a process for training a noise filter neural network, in accordance with aspects of the invention.

FIG. 4b is a flow diagram of a process for training an auditory activity of interest neural network, in accordance with aspects of the invention.

FIG. 5 is a flow diagram of a further process for determining auditory activities of interest, in accordance with aspects of the invention.

FIG. 6 is a flow diagram of a process for determining filter parameters, in accordance with aspects of the invention.

FIG. 7 is a flow diagram of a process for determining auditory activities of interest parameters, in accordance with aspects of the invention.

FIG. 8 is a block diagram of an example network edge device, in accordance with aspects of the invention.

FIG. 9 is a screen shot showing an example activity of interest report, in accordance with aspects of the invention.

### DETAILED DESCRIPTION

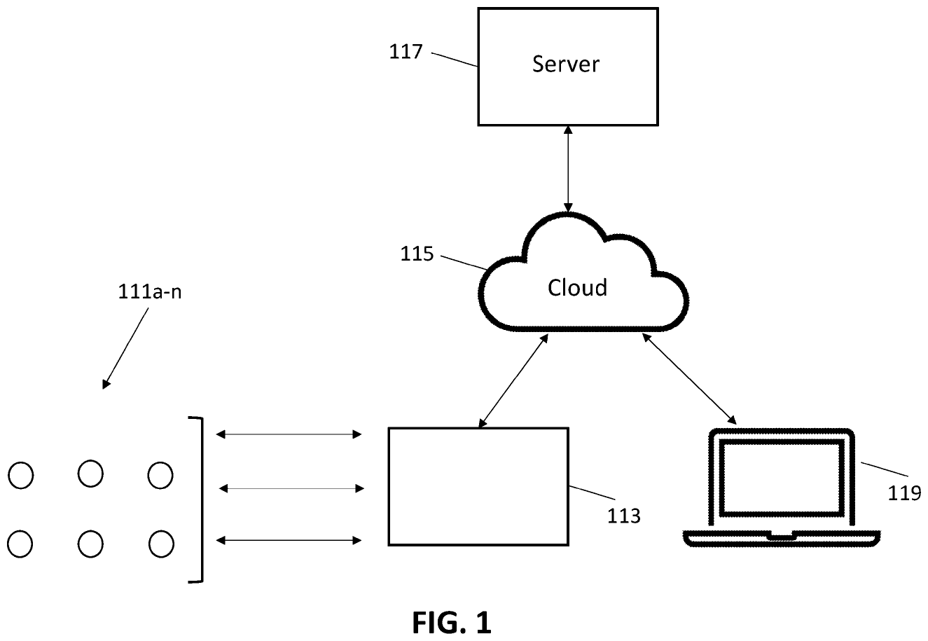

FIG. 1 is semi-block diagram of a system for determining activity of interest related to livestock health and/or welfare using neural network equipped edge devices. In some embodiments the activity of interest is auditory activity of interest. In some embodiments the activity of interest is visual activity of interest. In some embodiments the activity of interest is temperature activity of interest. In some embodiments the activity of interest is aerosol activity of interest. In some embodiments the activity of interest is visual activity in the infra-red region of interest. The system includes a plurality of network edge devices 111a-n. The edge devices include a sensor and a processor. In some embodiments the processor may be replaced by an ASIC or other circuitry. In some embodiments the sensor is a sound sensor. In various embodiments the sensor provides a digital output indicative of inputs received and processed by the sensor. In various embodiments the sensor is a sound sensor, and the sound sensor provides a digital output indicative of sounds received by the sound sensor. The sound sensor, in some embodiments, may include a MEMs microphone and circuitry to convert signals generated by the MEMs microphone to digital signals. In various embodiments the sensor may be another type of sensor, for example a temperature sensor or some other sensor.

The processor is configured by program instructions to process outputs of the sensor. In some embodiments the processor is configured to perform a transform on the sensor outputs, to perform activity of interest neural network processing on the transformed information to determine activities of interest, and command transmission of indications of activities of interest to a remote server or compute device. In some embodiments the processor is configured to transform outputs of the sensor from a time domain to a frequency domain. In some embodiments the processor is configured to perform a short-time Fourier transform (STFT) on the outputs of the sensor. In some embodiments the processor is configured to form bins, for example based on frequency, of results of the STFT. In some embodiments the processor performs activity of interest neural network processing using the bins to determine presence of auditory activities of interest.

In some embodiments the activity of interest neural network training is performed by a server 117. The server is shown as being accessible over a network or “cloud” 115 in FIG. 1, but in some embodiments the server may be considered to be part of the “cloud.” Although only one server is shown, in operation multiple servers may be used. Use of the server for training of the neural network may be beneficial in that the server may have significantly greater computational resources than the network edge device, which in some embodiments may be consider an Internet-of-things (IOT) device. In some embodiments the training includes providing the activity of interest neural network inputs representative of inputs associated with ill health of livestock and/or associated with poor welfare of livestock. In some embodiments the training includes providing the activity of interest neural network inputs representative of sounds associated with ill health of livestock and/or associated with poor welfare of livestock. For example, sounds, such as coughing sounds, have been identified and/or catalogued for a variety of diseases and ailments for a variety of animals, for example pigs and cattle. Similarly, sounds indicative of poor welfare of livestock have been similarly identified. After training, the activity of interest neural network may be loaded onto the network edge device.

In some embodiments the network edge device also includes a filter for filtering output of the sensor. In some such embodiments the network edge device may include a noise filtering neural network for determining settings or parameters for the filter. In such embodiments, the noise filtering neural network may be provided binned STFT outputs of the audio sensor, with the noise filtering neural network determining the settings or parameters for the filter. The settings or parameters may, for example, be in the form of weights or coefficients for use in an IIR or FIR filter. In some embodiments the settings or parameters may be for use by ADC circuitry of the audio sensor.

The noise filtering neural network may also be trained on the server. In some embodiments the noise filtering neural network may be trained using binned STFT information generated from ambient sounds taken from a location of interest, or a location similar to the location of interest. The location of interest may be, for example, an enclosure of a pig farm holding pigs, a range having cattle grazing, etc. The noise filtering neural network may therefore be trained to determine filter settings to reduce the effects of ambient noise on information provided to the activity of interest neural network. As with the activity of interest neural network, the noise filtering neural network may be loaded onto the network edge device.

In some embodiments the activity of interest neural network and the noise filtering neural network may be downloaded from the server onto the network edge device. In some such embodiments the neural networks may pass through a router or other network device 113, which provides for data communication between the network edge devices and the Internet 115.

In some embodiments the network edge devices may be spread about a pig farm, with one or more network edge devices per pig enclosure. In some embodiments the network edge devices may be spread about a range utilized by cattle. In some embodiments each cow or bull may be provided their own network edge device.

In operation the network edge devices monitor conditions, for example audio conditions, in areas around livestock. In monitoring the conditions, the network edge devices, using their activity of interest neural networks, determine if an activity of interest has occurred. If so, the network edge devices provide a report of the activity of interest, with for example the report being provided to a server maintaining data regarding occurrences of the activity of interest. The server may be accessible using the Internet, in some embodiments, and in some embodiments the server may be considered a “cloud” server. Reports regarding the occurrences of activity of interest may be viewed by a farmer or rancher on a display of a compute device, for example laptop 119, so that the farmer or rancher may be alerted to the activity and take corrective actions.

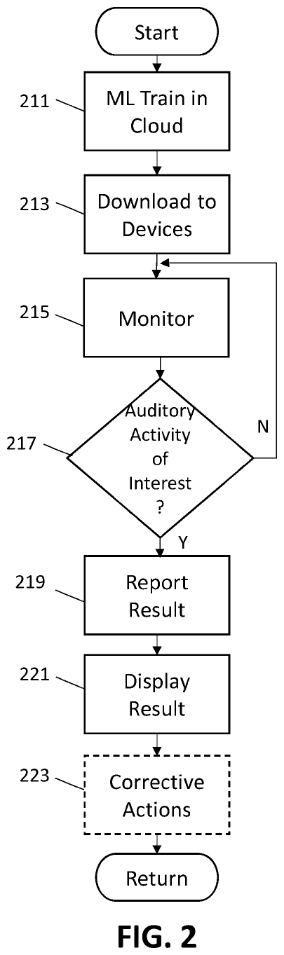

FIG. 2 is a flow diagram of a process including determining auditory activities of interest relating to livestock health and/or welfare. In some embodiments the process is performed, at least in part, by a system, for example the system of FIG. 1. In some embodiments the process is performed, at least in part, by a plurality of processors. In some embodiments the process is performed by network edge devices, at least one server, and at least one compute device, for example a laptop, personal computer, tablet computer, or smartphone.

In block 211 the process performs machine learning training of at least one neural network. In some embodiments the training is provided by a server or other computational device accessible via the Internet. In some embodiments the server or other computation device has significantly greater computational power than a network edge device. In some embodiments the server or other computation device includes an operating system that supports machine learning training packages while the network edge devices do not. In some embodiments the neural network is an activity of interest neural network. In some embodiments the activity of interest neural network is a convolutional neural network. In some embodiments the neural network includes at least one middle layer. In some embodiments the neural network includes a plurality of middle layers. In some embodiments the at least one neural network comprises a plurality of neural networks. In some embodiments the plurality of neural networks include a noise filtering neural network. In some embodiments training of the activity of interest neural network is performed using information of indicative of poor health and/or welfare of livestock. In some embodiments training of the activity of interest neural network is performed using information of sounds indicative of poor health and/or welfare of livestock. In some embodiments training of the noise filtering neural network is performed using information of ambient sounds of a range or enclosure for livestock. In some embodiments the information of ambient sounds of the range or enclosure includes information of sounds from livestock on the range or in the enclosure.

In block 213 the process downloads the trained neural networks to network edge devices. In some embodiments the process the server or other computation device and the network edge devices are both coupled to the Internet, and the process downloads the neural networks over the Internet. In some embodiments the network edge devices include at least one sensor and at least one processor, with the neural networks being downloaded to the processor of the network edge devices. The sensor may be a sound sensor. In some embodiments the activity of interest is an auditory activity of interest. In some embodiments the auditory activity of interest is particular auditory activity generated by livestock. In some embodiments the activity of interest is a vocal activity of interest. In some embodiments the vocal activity of interest is particular vocal activity of livestock.

In block 215 the process monitors for activities of interest. In most embodiments, the network edge devices are used for monitoring for activities of interest. In some embodiments the network edge devices are placed in or about livestock enclosures, and the process monitors for activities of interest in the livestock enclosures. In some embodiments the network edge devices are placed on livestock, and the process monitors for activities of interest from the livestock. In some embodiments the sound sensors of the network edge devices receive sounds, for example from the livestock, and convert the sounds to digital signals. The digital signals may be filtered, for example using filters of the network edge device. In some embodiments parameters for the filters may be determined by a noise filter neural network of the network edge devices. The filtered signals may be transformed into the frequency domain, for example using a STFT performed by a processor of the network edge device. The transformed signals may be used to provide generate frequency bins, by the network edge device processor, the information of which is provided to the activity of interest neural networks executing on the processors. The frequency bins may be used so as to reduce numbers of inputs to the neural networks.

In block 217 the process determines if an auditory activity of interest has occurred. In most embodiments the process determines if an auditory activity of interest occurred based on outputs of the activity of interest neural networks. If no auditory activity of interest has occurred, the process continues monitoring in block 215. Otherwise the process goes to block 219.

In block 219 the process reports a result of the monitoring. In most embodiments the result is the determination that an auditory activity of interest occurred. In some embodiments the reported result is that a particular auditory activity of interest, the particular auditory activity of interest being one of potentially a plurality of auditory activities of interest. In some embodiments the result is reported by the network edge device. In some embodiments the network edge device transmits a message indicative of the result over a network. In some embodiments the network includes the Internet. In some embodiments the result is transmitted to a server accessible by way of the Internet.

In block 221 the process displays the result. In some embodiments the result is displayed on a compute device of a farmer or rancher associated with the livestock being monitored. In some embodiments the result includes an identification of the activity of interest and a location of a network edge device reporting the result.

In optional block 223 a corrective action regarding the livestock is performed. The corrective action may be performed by or at the behest of the farmer or rancher.

The process thereafter returns. In some embodiments the process may return to block 215, and continue monitoring operations.

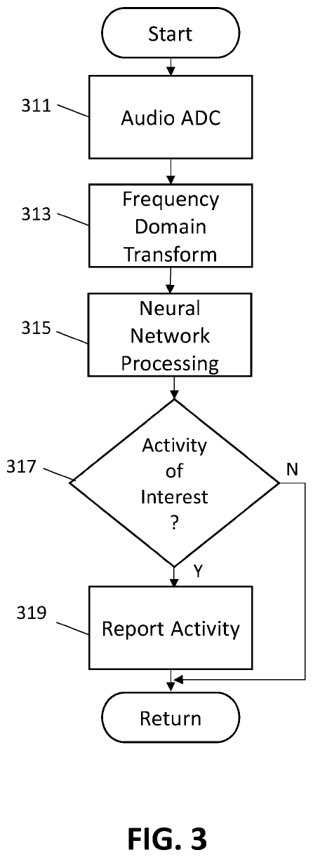

FIG. 3 is a flow diagram of a process for determining auditory activities of interest. In some embodiments the process is performed by a system, for example the system of FIG. 1. In some embodiments the process is performed by a network edge device, for example a network edge device of FIG. 1. In some embodiments the process is performed, at least in part, by one or more processors. In some embodiments the process of FIG. 3 performs operations of blocks 215-219 of the process of FIG. 2.

In block 311 the process digitizes an audio signal. In some embodiments the digitization of the audio signal is performed by circuitry of or associated with a sound sensor of a network edge device.

In block 313 the process transforms the digitized audio signal to the frequency domain. In some embodiments the process transforms the digitized signal using a STFT. In some embodiments the transform is performed by a processor of the network edge device. In some embodiments the process additionally stores information of the transformed signal in frequency bins.

In block 315 the process performs neural network processing of the transformed signal. In some embodiments the process performs neural network processing of the binned transformed signal. In most embodiments the process performs the neural network processing using an activity of interest neural network. In some embodiments the neural network processing is performed by an activity of interest neural network executing on the processor of the network edge device.

In block 317 the process determines if an activity of interest occurred. In some embodiments the process determines that an activity of interest occurred if an output of the activity of interest neural network indicates that an activity of interest occurred. If so, the process continues to operations of block 319, otherwise the process returns.

In block 319 the process reports the activity of interest. In some embodiments the network edge device transmits a message indicating that the activity of interest occurred. In some embodiments the message indicates a time of the activity of interest and a type of the activity of interest.

The process thereafter returns.

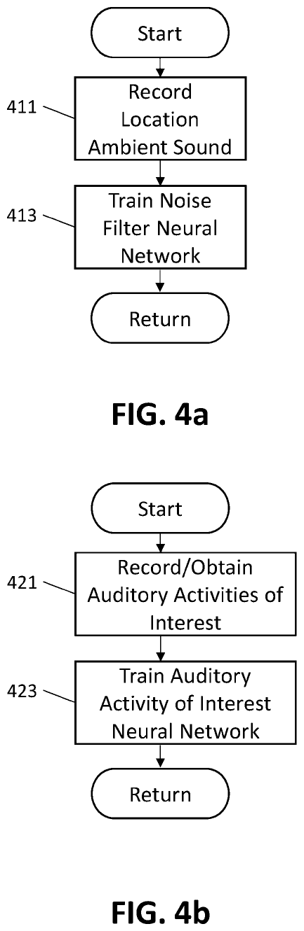

FIG. 4a is a flow diagram of a process for training a noise filter neural network. In some embodiments the process is performed, at least in part, by a system, for example the system of FIG. 1. In some embodiments the process is performed, at least in part, by at least one processor. In some embodiments the process is performed, at least in part, by a server. In some embodiments the process of FIG. 4a performs operations of block 211 of the process of FIG. 2.

In block 411 ambient sound for a livestock enclosure or range is recorded or obtained. In some embodiments the livestock enclosure or range is populated with livestock. In some embodiments the ambient sound is digitized, transformed into the frequency domain, and binned.

In block 413 the process trains a neural network using information of the ambient sound. In some embodiments the neural network is trained to determine filter parameters or coefficients for use in filtering ambient sounds in the livestock range or enclosure. In some embodiments the so-trained neural network is a noise filter neural network.

The process thereafter returns.

FIG. 4b is a flow diagram of a process for training an auditory activity of interest neural network. In some embodiments the process is performed, at least in part, by a system, for example the system of FIG. 1. In some embodiments the process is performed, at least in part, by at least one processor. In some embodiments the process is performed, at least in part, by a server. In some embodiments the process of FIG. 4b performs operations of block 211 of the process of FIG. 2.

In block 421 auditory activities of interest are recorded or obtained. In some embodiments the auditory activities of interest are sounds indicative of disease in livestock and/or poor welfare of livestock. In some embodiments the auditory activities of interest are digitized, transformed into the frequency domain, and binned.

In block 423 the process trains a neural network using information of the auditory activities of interest. In some embodiments the neural network is trained to determine if an auditory activity of interest has occurred. In some embodiments the so-trained neural network is an activity of interest neural network.

The process thereafter returns.

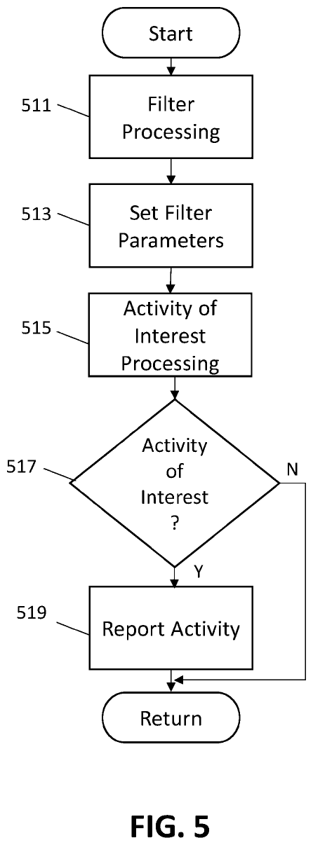

FIG. 5 is a flow diagram of a further process for determining auditory activities of interest. The process of FIG. 5 includes filter processing. In some embodiments the process is performed by a system, for example the system of FIG. 1. In some embodiments the process is performed by a network edge device, for example a network edge device of FIG. 1. In some embodiments the process is performed, at least in part, by one or more processors. In some embodiments the process is performed by a processor of a network edge device. In some embodiments the process of FIG. 3 performs operations of blocks 215-219 of the process of FIG. 2.

In block 511 the process performs filter processing. In some embodiments the process performs filter processing by providing sound information to a noise filter neural network and having the noise filter neural network operate based on the sound information. In some embodiments the sound information is information of sounds generated by a sound sensor, that has been transformed into the frequency domain, for example using a STFT, and binned. In some embodiments the transforming of the information of sounds and the binning is performed as part of the filter processing. In some embodiments the noise filter neural network determines filter parameters using the sound information. In some embodiments the sound sensor is a sound sensor of a network edge device, and the noise filter neural network executes on a processor of the network edge device.

In block 513 the process sets filter parameters of a filter using the filter parameters determined by the noise filter neural network. In some embodiments the filter is a filter of the network edge device. In some embodiments the filter is an IIR filter. In some embodiments the filter is a FIR filter. In some embodiments the filter is associated with an ADC of the sound sensor.

In block 515 the process performs activity of interest processing. In some embodiments the process performs activity of interest processing by providing sound information to an activity of interest neural network and having the activity of interest neural network operate based on the sound information. In some embodiments the sound information is information of sounds generated by a sound sensor, that has been filtered by the filter, transformed into the frequency domain, for example using a STFT, and binned. In some embodiments the transforming of the information of sounds and the binning is performed as part of the activity of interest processing. In some embodiments the activity of interest neural network executes on the processor of the edge device.

In block 517 the process determines if an activity of interest occurred. In some embodiments the process determines that an activity of interest occurred if an output of the activity of interest neural network indicates that an activity of interest occurred. If so, the process continues to operations of block 519, otherwise the process returns.

In block 519 the process reports the activity of interest. In some embodiments the network edge device transmits a message indicating that the activity of interest occurred. In some embodiments the message indicates a time of the activity of interest and a type of the activity of interest.

The process thereafter returns.

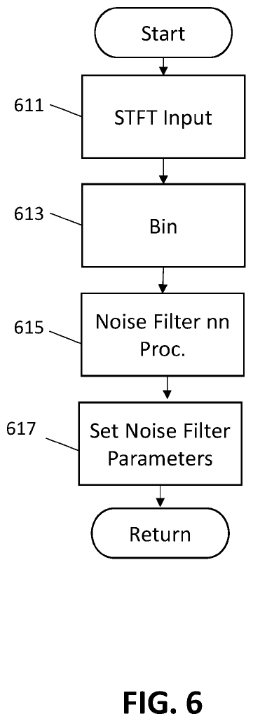

FIG. 6 is a flow diagram of a process for determining filter parameters. In some embodiments the process is performed by a system, for example the system of FIG. 1. In some embodiments the process is performed by a network edge device, for example a network edge device of FIG. 1. In some embodiments the process is performed, at least in part, by one or more processors. In some embodiments the process is performed by a processor of a network edge device. In some embodiments the process performs operations of blocks 511 and 513 of the process of FIG. 5.

In block 611 the process performs an STFT on an input signal. In some embodiments the input signal is an output of a sound signal. In some embodiments the input signal is a digital output of a sound sensor. In some embodiments the sound sensor is a sound sensor of a network edge device.

In block 613 the process bins the transformed signal. In some embodiments the bins are frequency bins.

In block 615 the transformed and binned signal is operated on by a noise filter neural network. The noise filter neural network determines filter parameters.

In block 617 the filter parameters are provided to a filter.

The process thereafter returns.

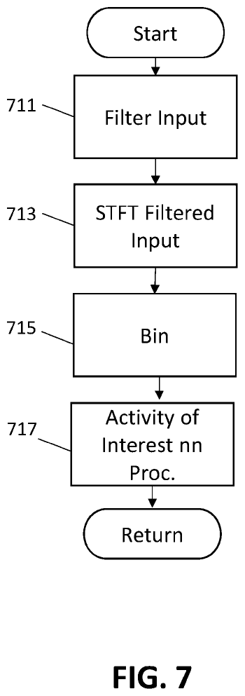

FIG. 7 is a flow diagram of a process for determining auditory activities of interest parameters. In some embodiments the process is performed by a system, for example the system of FIG. 1. In some embodiments the process is performed by a network edge device, for example a network edge device of FIG. 1. In some embodiments the process is performed, at least in part, by one or more processors. In some embodiments the process is performed by a processor of a network edge device. In some embodiments the process performs operations of block 515 of the process of FIG. 5.

In block 711 the process filters an input signal. In some embodiments the filter has parameters set by the process of FIG. 6. In some embodiments the input signal is an output signal of a sound sensor.

In block 713 the process performs an STFT on the filtered signal.

In block 613 the process bins the filtered, transformed signal. In some embodiments the bins are frequency bins.

In block 615 the filtered, transformed, and binned signal is operated on by an activity of interest neural network. The activity of interest neural network determines if an activity of interest has occurred.

The process thereafter returns.

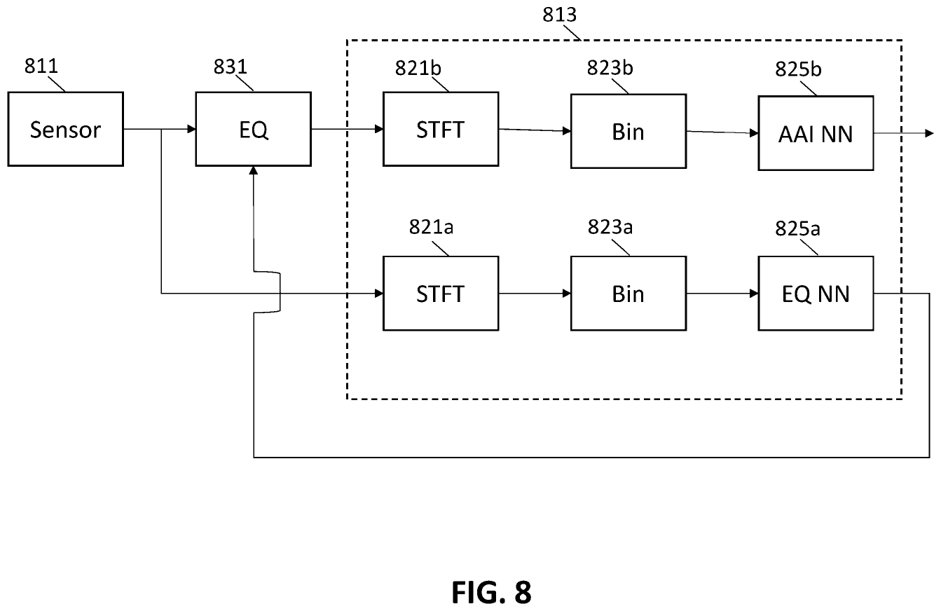

FIG. 8 is a block diagram of an example network edge device. The example network edge device may be a network edge device of FIG. 1. The network edge device includes a sensor 811 and a processor 813. In addition, the network edge device may include network communications capabilities (not shown in FIG. 8), such as one or more of Bluetooth circuitry, Wi-Fi circuitry, Ethernet circuitry, or other communication circuitry.

The sensor may be a sound sensor. The sound sensor may include a filter to filter output of the sound sensor, or a filter may be provided as a separate component, at least in part, of the network edge device. FIG. 8 shows a separate filter 831, although in some embodiments some portions of the filter may be implemented as part of the processor, while other portions, for example inductive components, may be implemented separate from the processor.

The processor includes two processing chains. A first processing chain includes an STFT module 821b, a binning module 823b, and an activity of interest neural network 825b, all arranged to operate sequentially on a signal provided by the filter. Outputs of the activity of interest neural network may be transmitted over a network. In some embodiments the processor additionally includes logic to, for example, command transmission of messages indicative of outputs of the activity of interest neural network when the neural network indicates an activity of interest has occurred. A second processing chain includes a further STFT module 821a, a further binning module 823a, and a noise filter neural network 825a, all arranged to operate sequentially on a signal provided by the sound sensor. Outputs of the noise filter neural network may be used to set filter parameters of the filter. In some embodiments operations of the first processing chain, or operations of the activity of interest neural network, are not performed until after operations of the second processing chain have set the filter parameters of the filter. In some embodiments a register or other signal is set to indicate when operations of the noise filter neural network have provided outputs for use in setting the filter parameters, and the register or other signal is used to indicate that operations of the first processing chain, or operations of the activity of interest neural network, may be performed. In some embodiments the register or other signal is used to indicate that outputs of the activity of interest neural network are valid. In some embodiments, use of the register or other signal may reduce numbers of false positives from the activity of interest neural network.

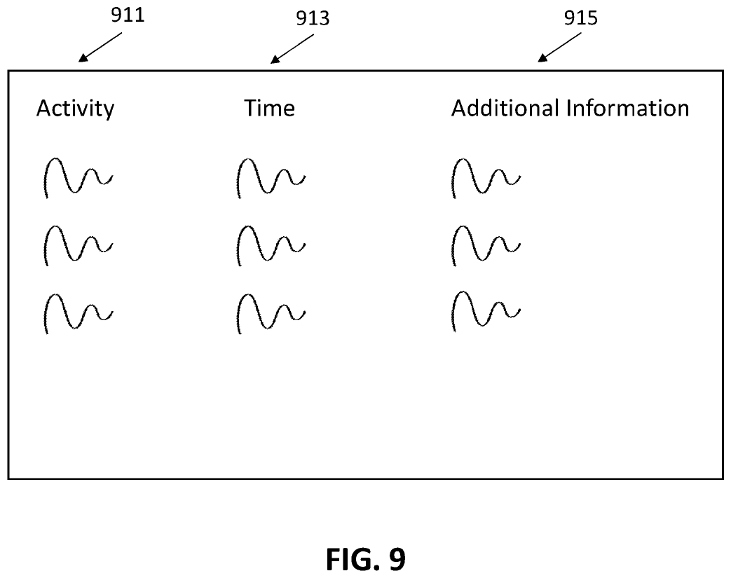

FIG. 9 is a screen shot showing an example activity of interest report. The screen shot may be of a display of a compute device, for example the compute device of FIG. 1. The screen shot shows a column labeled “Activity” 911, a column labeled “Time” 913, and a column labeled “Additional Information” 915. The Activity column may include information indicating activity of interest detected by network edge devices, for example the network edge devices of FIG. 1. The Time column may indicate time of occurrence of the activity of interest. The Additional Information may include additional information, for example further information regarding the activity of interest and/or information regarding the network edge device reporting the activity, for example location of the network edge device.

Although the invention has been discussed with respect to various embodiments, it should be recognized that the invention comprises the novel and non-obvious claims supported by this disclosure.

1. A method for determining activity of interest relating to animal health and/or welfare, comprising:
for each of a plurality of sensors and
receiving, from the sensor, a signal indicative of input sensed by the sensor relating to an animal;
performing, by a processor, a transform on the received signal;
performing, by the processor, activity of interest neural network processing on the transformed signal to determine if an activity of interest has occurred, the activity of interest occurring if the sensed input is indicative of ill health and/or poor welfare of the animal; and
transmitting an indication of the activity of interest to a server.

2. The method of claim 1, further comprising filtering the signal indicative of input sensed by the sensor relating to the animal, and wherein the processor performs the transform on the filtered received signal.

3. The method of claim 2, further comprising binning the transformed signal, and wherein the processor performs activity of interest neural network processing on the binned, transformed signal.

4. The method of claim 1, wherein at least one sensor is selected from the group consisting of: audio sensor, image sensor, temperature sensor, aerosol sensor, and infra-red sensor.

5.-8. (canceled)

9. The method of claim 3, wherein the transform is a short-time Fourier transform (STFT) and the binning of the transformed signal pools results of the STFT into frequency bins.

10. The method preceding claim 1, wherein each of the sensors is paired with a processor to form a network edge device.

11. The method of claim 1, further comprising:
performing machine learning training, on a server, to train a neural network to identify activity of interest of an animal, the activity of interest being ill health and/or poor welfare of an animal; and
downloading the trained neural network to the processors.

12. The method of claim 11, wherein the machine learning training is performed using information indicative of ill health and/or poor welfare of an animal.

13. The method of claim 11, wherein the sensors are sound sensors, and the machine learning training is performed using information of sounds indicative of ill health and/or poor welfare of an animal.

14. The method of claim 1, further comprising filtering the received signal, and wherein the processor performs the transform on the filtered received signal.

15. The method of claim 14, wherein a noise filter neural network performs the filtering of the received signal by operating on the received signal.

16. The method of claim 14, wherein a noise filter neural network determines filter parameters of a filter to filter the received signal.

17. The method of claim 16, further comprising:
performing machine learning training, on a server, to train a noise filter neural network to determine filter parameters to filter ambient sounds in an animal range or enclosure; and
downloading the trained noise filter neural network to the processors.

18. The method of claim 17, wherein the machine learning training of the noise filter neural network is performed using ambient sounds in the animal range or enclosure.

19. The method of claim 1, wherein the animal is pigs, and wherein the sensors are spread about a pig farm.

20. (canceled)

21. The method of claim 1, wherein the animal is cattle, and wherein the sensors are spread about a range utilized by cattle.

22. (canceled)

23. A system for determining activity of interest relating to animal health and/or welfare, comprising:
a plurality of network edge devices, the network edge devices each including a sensor and a processor, the processor configured to perform a transform on sensor outputs, to perform activity of interest neural network processing on the transformed sensor outputs to determine occurrence of an activity of interest relating to animal health and/or welfare, and to command transmission of indications of occurrence of activities of interest to a remote compute device.

24. The system of claim 23, wherein the network edge devices additionally include a filter for filtering output of the sensor.

25. The system of claim 23, wherein the network edge devices additionally include network communication circuitry.

26. The system of claim 23, wherein the transform is a short-time Fourier transform (STFT).

27. The system of claim 26, wherein the processor is further configured to bin results of the STFT, with the processor configured to perform activity of interest neural network processing on the binned results of the STFT.

28. The system of claim 23, wherein the processor is configured to perform activity of interest neural network processing using a neural network trained to identify signals indicative of ill health and/or poor welfare of an animal.

29. The system of claim 23, wherein at least one sensor is selected from the group consisting of: an audio sensor, image sensor, temperature sensor, aerosol sensor, and infra-red sensor.

30.-33. (canceled)

34. The system of claim 29, wherein the signals indicative of diseased animal comprise sounds indicative of ill health and/or poor welfare of an animal.

35. The system of claim 23, wherein the network edge devices additionally include a filter for filtering output of the sensor.

36. The system of claim 35, wherein the processor includes a first processing chain including a first short-time Fourier transform (STFT) module, a first binning module, and an activity of interest neural network, arranged to operate sequentially on a signal provided by the filter, and a second processing chain including a second STFT module, a second binning module, and a network filter neural network, also arranged to operate sequentially on the signal provided by the filter.

37. The method of claim 1, wherein:
the transformed signal is a first transformed signal; and
performing, by the processor, activity of interest neural network processing on the transformed signal to determine if an activity of interest has occurred further includes:
providing at least a second transformed signal from another sensor for activity of interest neural network processing together with the first transformed signal.
